(19) United States
(12) Patent Application Publication
(10) Pub. No.: US 2016/0204428 A1
(43) Pub. Date: Jul. 14, 2016

(54) NEGATIVE ELECTRODE FOR NONAQUEOUS-ELECTROLYTIC-SOLUTION SECONDARY CELLS, NONAQUEOUS-ELECTROLYTIC-SOLUTION SECONDARY CELL, AND METHOD FOR FABRICATING NEGATIVE ELECTRODE FOR NONAQUEOUS-ELECTROLYTIC-SOLUTION SECONDARY CELLS

(71) Applicant: TOPPAN PRINTING CO., LTD., Tokyo (JP)

(72) Inventor: Kenji SUGAWARA, Tokyo (JP)

(73) Assignee: TOPPAN PRINTING CO., LTD., Tokyo (JP)

(21) Appl. No.: 15/077,306

(22) Filed: Mar. 22, 2016

Related U.S. Application Data
(63) Continuation of application No. PCT/JP2014/004909, filed on Sep. 25, 2014.

(30) Foreign Application Priority Data
Sep. 26, 2013 (JP) 2013-200243
Sep. 26, 2013 (JP) 2013-200244
Mar. 18, 2014 (JP) 2014-055549

(51) Int. Cl. H01M 4/36; H01M 10/052; H01M 4/04; H01M 4/62; H01M 4/587

(52) U.S. Cl. CPC H01M 4/366; H01M 4/622; H01M 4/587; H01M 4/0404; H01M 10/052; H01M 4/364; H01M 2004/027

(57) ABSTRACT

A negative electrode for nonaqueous-electrolytic-solution secondary cells is provided. The negative electrode for nonaqueous-electrolytic-solution secondary cells includes a first active substance layer on a current collector, and a second active substance layer covering the first active substance layer. The first active substance layer is one containing a first active substance capable of reversibly alloying with lithium, a conductive aid and a binder resin, and the second active substance layer is one containing a second active substance capable of reversibly absorbing and releasing lithium, a conductive aid and a binder resin.

### CROSS-REFERENCE TO RELATED PATENT APPLICATIONS

This application is a continuation application filed under 35 U.S.C. §111(a) claiming the benefit under 35 U.S.C. §§120 and 365(c) of PCT International Application No. PCT/JP2014/004909, filed on Sep. 25, 2014, which is based upon and claims the benefit of priority of Japanese Application No. 2013-200243, filed on Sep. 26, 2013, Japanese Application No. 2013-200244, filed on Sep. 26, 2013, and Japanese Application No. 2014-055549, filed Mar. 18, 2014, the entire contents of them all are hereby incorporated by reference.

### TECHNICAL FIELD

This invention relates to a negative electrode for nonaqueous-electrolytic-solution secondary cells, typical of which is a lithium ion secondary cell, and its fabrication method and a technique on nonaqueous-electrolytic-solution secondary cells provided with the same.

### BACKGROUND

Lithium ion secondary cells have features in that they are high in energy density and make use of non-aqueous electrolytes, for which a high voltage can be obtained, and a memory effect that is smaller than those of other secondary cells, such as nickel-cadmium cells. Thus, studies and developments of lithium ion secondary cells have been in progress for use as a power source of note-type personal computers and mobile phones and also for applications to next-generation electric industrial products such as of electric bicycles, electric cars and the like.

The reaction of a lithium ion secondary cell is established with active substances capable of absorbing and releasing lithium in positive and negative electrodes. At present, a carbon material such as graphite is used as a negative electrode active substance and a theoretical capacity of graphite is as small as 372 mAh/g and thus, conversion to higher capacity has been expected.

Hence, attention has been paid to Si (about 4200 mAh/g), Sn (about 990 mAh/g) and the like as an active substance capable of absorbing and releasing a greater amount of lithium by the alloying reaction with lithium. However, when such an active substance is alloyed with lithium during charge, its volume is expanded to about four times larger and is shrunk during discharge. When the charge and discharge cycles in use are repeated with time, the active substance is gradually divided into fine pieces by the repetitions of the great volumetric change, with the problem that there is some concern that characteristics lower because of the fall-off from the electrode.

As a measure against the above problems, there have been proposed the particles of a composite active substance wherein Si particles are coated with a carbon layer (PTL 1), and the particles of a composite active substance wherein graphite particles are coated with an organic material or an alloy-based active substance layer (PTLs 2, 3). Moreover, such a structure that a metal thin film layer is formed on an alloy-based active substance layer is disclosed (PTL 4). Additionally, a structure is disclosed wherein a layer made mainly of a conductive agent is provided between layers of Si used as an active substance (PTL 5).

However, with the measures set out in PTLs 1-3, the use of the coating layer alone cannot be lead to sufficient suppression of the division into fine particles ascribed to the great volumetric change of the alloy-based active substance particles. With the measure described in PTL 4, the metal thin film layer of the surface is so thin and hard that the volumetric change of the underlying alloy-based active substance layer cannot be absorbed. Moreover, with the measure described in PTL 5, Si is exposed to the layer surface, so that the fall-off of the active substance from the surface cannot be prevented. In addition, the intermediate layer made mainly of a conductive agent undergoes no or little volumetric change and is insufficient to alleviate the stress generated during the volumetric change of Si.

### CITATION LIST

### Patent Literature

### PTL 1: JP-A-2001-283843

### PTL 2: JP-B-3769647

### PTL 3: JP-B-3103356

### PTL 4: JP-A-2007-019032

### PTL 5: JP-A-2006-196247

### SUMMARY OF THE INVENTION

### Technical Problem

An object of the invention is to provide an electrode for nonaqueous-electrolytic-solution secondary cells having a high performance and a long life while taking the problems in the background art into account.

### Solution to Problem

In order to attempt to improve or even solve the above problems, a negative electrode for nonaqueous-electrolytic-solution secondary cells according to an embodiment of the invention includes a first active substance layer formed on a current collector, and a second active substance layer covering the first active substance layer, characterized in that the first active substance layer is a layer containing a first active substance capable of reversibly alloying with lithium, a conductive aid and a binder resin, and the second active substance layer is a layer containing a second active substance capable of reversibly absorbing and releasing lithium without alloying with lithium, a conductive aid and a binder resin.

A method for making a negative electrode for nonaqueous-electrolytic-solution secondary cells according to another embodiment of the invention comprises forming, on a current collector, a first active substance layer containing a first active substance capable of reversibly alloying with lithium, a conductive aid and a binder resin, a second active substance layer containing a second active substance capable of reversibly absorbing and releasing lithium without alloying with lithium, a conductive aid and a binder resin, and a mixed layer provided as at least one interlayer between the first active substance layer and the second active substance layer adjacent to each other and formed by mixing at least a part of the constituent substances of one of the adjacent layers and at least a part of the constituent substances of the other layer, characterized by comprising the steps of successively coating and drying slurries for the respective active substance layers onto the current collector wherein the binder resin of one of the adjacent active substance layers is dissolved in a solvent of the slurry for the other active substance layer to form the mixed layer between the adjacent active substance layers.

Another method for making a negative electrode for nonaqueous-electrolytic-solution secondary cells according to a further embodiment of the invention comprises forming, on a current collector, a first active substance layer containing a first active substance capable of reversibly alloying with lithium, a conductive aid and a binder resin, a second active substance layer containing a second active substance capable of reversibly absorbing and releasing lithium without alloying with lithium, a conductive aid and a binder resin, and a mixed layer provided as at least one interlayer between the first active substance layer and the second active substance layer adjacent to each other and formed by mixing at least a part of the constituent substances of one of the adjacent layers and at least a part of the constituent substances of the other layer, characterized by comprising the steps of successively coating and drying slurries for the respective active substance layers onto the current collector, and subsequently pressing the stacked active substance layers simultaneously, whereby the mixed layer is formed between the adjacent active substance layers by the pressing.

A method for making a negative electrode for nonaqueous-electrolytic-solution secondary cells according to a further embodiment of the invention by forming a plurality of active substance layers on a current collector, the method comprising alternately stacking, one by one, at least one first active substance containing a first active substance capable of reversibly alloying with lithium, a conductive aid and a binder resin and at least one second active substance layer containing a second active substance, a conductive aid and a binder resin in such a way that the second active substance layer is an outermost active substance layer of the negative electrode for nonaqueous-electrolytic-solution secondary cells, characterized by comprising the steps of:

forming pores in the first active substance layer; and

filling the second active substance layer in the pores of the first active substance layer to form a mixed layer at the interface between the first active substance layer and the second active substance layer.

### Proposed Effect of Invention

According to the embodiments of the invention, the negative electrode has such a structure that a first active substance layer containing a first active substance capable of reversibly alloying with lithium, a conductive aid and a binder resin is formed on a current collector, and a second active substance layer containing a second active substance capable of reversibly absorbing and releasing lithium without alloying with lithium, a conductive aid and a binder resin is further formed to cover the first active substance layer therewith. In doing so, if the first active substance capable of reversibly alloying with lithium undergoes a big volumetric change caused by charge and discharge, the second active substance whose volumetric change caused by charge and discharge is small acts to try to buffer the big change, and the first active substance is not exposed to the outside surface of the layer, thus enabling the first active substance not to be dropped off and a negative electrode for nonaqueous-electrolytic-solution secondary cells of a higher capacity and a longer life to be attempted to be achieved.

With the case where the mixed layer is formed at the interface between the first and second active substance layers by choosing any of the step of dissolving the binder resin of the first active substance layer in a solvent of the slurry for forming the second active substance layer, the step of pressing a negative electrode formed with the first and second active substance layers simultaneously, or the step of filling the second active substance layer in the pores formed in the first active substance layer, the interfacial adhesion between both layers is improved, thereby enabling the attempted provision of a negative electrode for nonaqueous-electrolytic-solution secondary cells having a higher capacity and a longer life.

### BRIEF DESCRIPTION OF THE DRAWINGS

FIG. 1 is a schematic illustrative view of a section of an essential part of a negative electrode for nonaqueous-electrolytic-solution secondary cells according to a first embodiment of the invention.

FIG. 2 is a schematic illustrative view of a section of an essential part of the negative electrode for nonaqueous-electrolytic-solution secondary cells according to the first embodiment of the invention.

FIG. 3 is a schematic illustrative view of a section of an essential part of a negative electrode for nonaqueous-electrolytic-solution secondary cells according to a second embodiment of the invention.

FIG. 4 is a schematic illustrative view of a section of an essential part of the negative electrode for nonaqueous-electrolytic-solution secondary cells according to the second embodiment of the invention.

FIG. 5 is a schematic illustrative view of a section of an essential part of a negative electrode for nonaqueous-electrolytic-solution secondary cells according to a third embodiment of the invention.

FIG. 6 is a schematic illustrative view of a section of an essential part of the negative electrode for nonaqueous-electrolytic-solution secondary cells according to the third embodiment of the invention.

### DESCRIPTION OF REPRESENTATIVE EMBODIMENTS

The embodiments of the present invention are now described in detail with reference to the drawings to clarify the invention.

### <Configuration of a Negative Electrode of a First Embodiment>

The configuration of a negative electrode of a first embodiment according to the invention is illustrated with reference to the drawings.

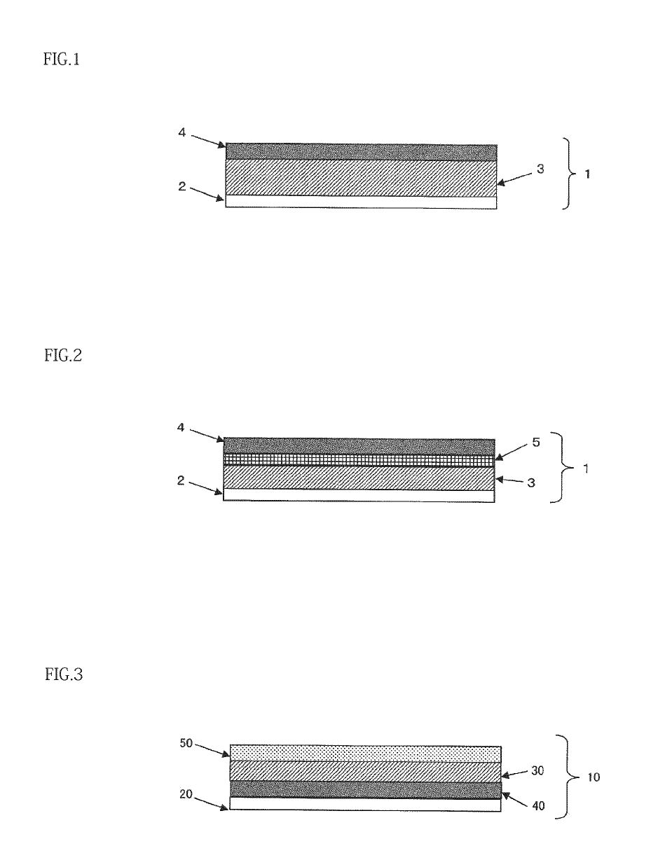

FIGS. 1 and 2 schematically show a schematic illustrative view of a section of an essential part of a negative electrode for nonaqueous-electrolytic-solution secondary cells according to a first embodiment, respectively.

As shown in FIG. 1, a negative electrode 1 for non-aqueous electrolytic solution secondary cells (which may be sometimes referred to simply as negative electrode 1) has such a structure that a first active substance layer 3 is formed on a current collector 2, and a second active substance layer 4 covering the first active substance 3 is further formed. The first active substance layer 3 is a layer containing a first active substance capable of reversibly alloying with lithium, a conductive aid and a binder resin. The second active substance layer 4 is a layer containing a second active substance capable of reversibly absorbing and releasing lithium without alloying with lithium, a conductive aid and a binder resin.

In such a structure where the first active substance layer 3 is covered with the second active substance layer 4, if the first active substance capable of reversibly alloying with lithium undergoes a great volumetric change caused by charge and discharge, it is possible to try to prevent the first active substance from falling off since the first active substance is not exposed to the outside of the layer. Since the second active substance layer 4 contains a conductive aid and a binder resin and has flexibility sufficient to undergo a small volumetric change accompanied by charge and discharge, the stress of the volumetric change of the first active substance layer 3 as a whole is better buffered, so that the second active substance layer 4 is not broken and thus, the first active substance can be better prevented from falling off. As a consequence, the first active substance continues to effectively react even after repetition of charge and discharge cycles, thereby trying to improve charge and discharge cycle characteristics.

Further, as shown in FIG. 2, a mixed layer 5 wherein part of a component of the first active substance layer is incorporated in the second active substance layer may be formed between the first active substance layer 3 and the second active substance layer 4. This allows the interfacial adhesion between both layers 3, 4 to be improved and such an effect of the second active substance layer 4 as mentioned above to be promoted thereby more improving the charge and discharge cycle characteristics.

For example, when there is chosen the step of dissolving the binder resin of the first active substance layer 3 in a solvent of a slurry for forming the second active substance layer 4, or the step of pressing the negative electrode 1 formed thereon with the first and second active substance layers 3, 4 simultaneously, the mixed layer 5 of both layers is formed at the interface between the first and second active substance layers 3, 4.

### <Configuration of a Negative Electrode of a Second Embodiment>

Next, the negative electrode of a second embodiment of the invention is illustrated with reference to the drawings.

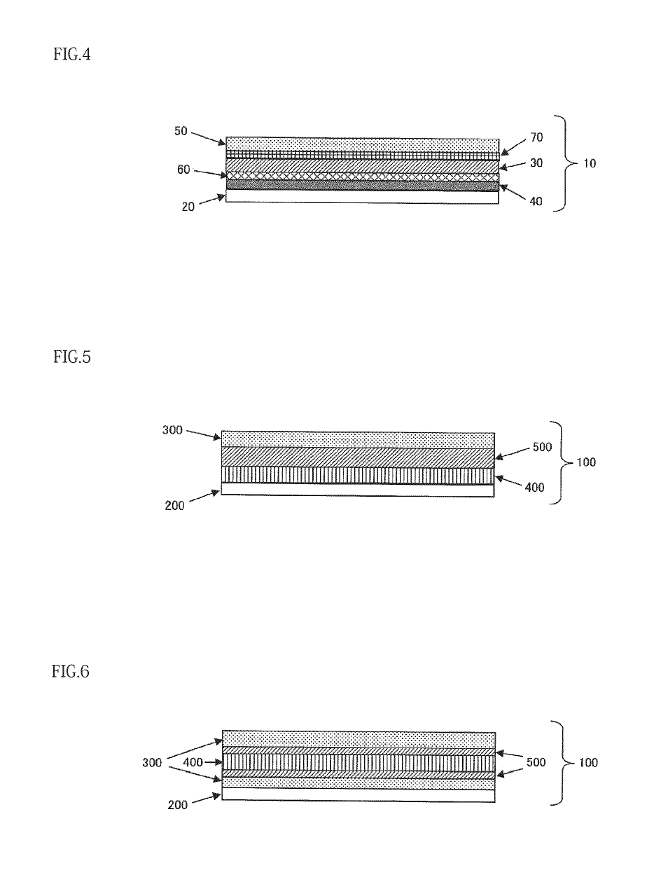

FIGS. 3 and 4 are an illustrative view schematically showing a section of an essential part of a negative electrode for nonaqueous-electrolytic-solution secondary cells according to the second embodiment.

As shown in FIG. 3, a negative electrode 10 for nonaqueous-electrolytic-solution secondary cells (which may be sometimes referred to merely as negative electrode 10 hereinafter) includes, on a current collector 20, a second active substance layer 40, a first active substance layer 30, and a third active substance layer 50 stacked in this order wherein the first active substance layer 30 is sandwiched from opposite sides thereof between the second active substance layer 40 and the third active substance layer 50. The first active substance layer 30 may be sandwiched between the second active substance layer 40 and the third active substance layer 50 by superposing the second active substance layer 40 and the third active substance layer 50 to form a pouch shape by peripheral sealing, and inserting the first active substance layer 30, followed by hermetic sealing. The first active substance layer 30 is one containing a first active substance capable of reversibly alloying with lithium, a conductive aid, and a binder resin. The second active substance layer 40 is one containing an active substance capable of reversibly absorbing and releasing lithium without alloying with lithium, a second conductive aid, and a binder resin. The third active substance layer 50 is one containing an active substance capable of reversibly absorbing and releasing lithium without alloying with lithium, a third conductive agent, and a binder resin.

The second and third active substance layers 40, 50, respectively, contain a conductive aid and a binder resin and have flexibility because a small volumetric change caused by charge and discharge occurs. Such a structure entails that if the first active substance capable of reversibly alloying with lithium undergoes a great volumetric change caused by charge and discharge, the second and third active substance layers 40, 50 at opposite sides of the first active substance layer 30 along the stacking direction act to well buffer the resulting stress thereby suppressing the breakage of the respective layers. Since the surface of the first active substance is not exposed the outside of the layer, the first active substance is better prevented from falling off. Since the second active substance layer is formed between the current collector and the first active substance layer, the active substance layer can be better suppressed from peeling off from the current collector. As a result, the active substance continues to effectively react after repetition of charge and discharge cycles thereby improving charge and discharge cycle characteristics.

By choosing either the dissolution of a binder resin of one of the adjacent active substance layers in a solvent of a slurry for forming the other active substance layer, or the step of pressing a negative electrode formed with the first to third active substance layers simultaneously, a mixed layer 60 may be formed at the interface between the first active substance layer 30 and the second active substance layer 40, or a mixed layer 70 may be formed at the interface between the first active substance layer 30 and the third active substance layer 50 as is particularly shown in FIG. 4. This eventually leads to improved interfacial adhesion of the respective layers, facilitates such effects of the respective active substance layers as mentioned before, and more improves the charge and discharge cycle characteristics. In FIG. 4, although the two mixed layers 60, 70 are shown, only one mixed layer may be used. The mixed layer is formed as a result of mixing of at least a part of the constituent substances of one of the adjacent layers and at least a part of the constituent substances of the other.

### <Effect of the Negative Electrode of the Second Embodiment>

According to the present embodiment, the negative electrode has such a structure including, on a current collector, the first active substance layer containing a first active substance capable of reversibly alloying with lithium, a conductive aid, and a binder resin, which is sandwiched between the second and third active substance layers containing second and third active substances capable of reversibly absorbing and releasing lithium without alloying with lithium, a conductive aid, and a binder resin, respectively. In doing so, if the first active substance capable of reversibly alloying with lithium undergoes a great volumetric change caused by charge and discharge, the second and third active substance layers that undergo a small volumetric change accompanied by charge and discharge act to well buffer the change, making it possible to better suppress the respective active substance layers from breaking down.

Further, since either the second or third active substance layer is formed between the current collector and the first active substance layer, the active substance layer can be better suppressed from peeling off from the current collector. In addition, since one of the second or third active substance layer is formed, the first active substance surface is not exposed to the outside of the layer, so that the first active substance can be better prevented from falling off. Accordingly, there can be attempted to be provided a negative electrode for nonaqueous-electrolytic-solution secondary cells having of a higher capacity and a longer life.

Moreover, where a mixed layer of adjacent active substance layers is formed, layer interfacial adhesion can be better improved thereby making it possible to try to provide a negative electrode for nonaqueous-electrolytic-solution secondary cells having a higher capacity and a longer life.

### <Configuration of a Negative Electrode of a Third Embodiment>

Next, the configuration of a negative electrode of a third embodiment according to the invention is illustrated with reference to the drawings.

FIGS. 5 and 6 are, respectively, a schematic illustrative view showing a section of an essential part of a negative electrode according to the third embodiment.

A negative electrode 100 for nonaqueous-electrolytic-solution secondary cells (which may be sometimes referred to simply as negative electrode 100 hereinafter) includes, on a current collector 200, a first active substance layer 400 and a second active substance layer 300 stacked alternately, as shown in FIGS. 5, 6, and thus has such a structure that the outermost active substance layer is the second active substance layer 300. As shown in FIG. 6, where a plurality of layers are stacked, the second active substance layers 300 may be placed on opposite sides of the first active substance layer 400 so as to form a pouch shape by peripheral sealing, and the first active substance layer 400 may be sandwiched such as by its insertion into the pouch and hermetic sealing.

The second active substance layer 300 is one containing a second active substance capable of reversibly absorbing and releasing lithium without alloying with lithium, a conductive aid and a binder resin. The first active substance layer 400 is one containing a first active substance capable of reversibly alloying with lithium, a conductive agent, and a binder resin.

The second active substance layer 300 contains a conductive aid and a binder resin, and has flexibility because the active substance used has a small volumetric change caused by charge and discharge. Accordingly, if the first active substance capable of reversibly alloying with lithium undergoes a great volumetric change caused by charge and discharge, the first active substance layer well acts as a buffer against stress, thereby suppressing the respective active substance layers from breaking down. Additionally, since the active substance of the first active substance layer 400 is not exposed on its surface to the outside, the active substance can be better prevented from falling off.

In the structure shown in FIG. 6, the second active layer 300 is formed between the current collector 200 and the first active substance layer 400, so that the active substance can be suppressed from peeling off from the current collector. As a consequence, the active substance continues to effectively react during the repetition of charge and discharge cycles, thus leading to improved charge and discharge cycle characteristics.

Further, the first active substance layer 400 is formed through a pore-forming step to form pores in the first active substance layer 400. This permits the second active substance layer 300 to be readily forced in the pores of the first active substance layer 400 by pressing thereby promoting the formation of a mixed layer 500 of the first and second active substances 400, 300 at the interface therebetween. Eventually, a better buffering action can be developed thereby better enabling the active substance layers from breaking down. It will be noted here that the second active substance layer 300 is forced in by the pressing, the pores of the first active substance layer 400 may be formed wider at the bottom (or inside) than at the opening. It is to be noted that the first active substance layer 400 is so configured that particles are partially bonded together through a resin binder, for which communication holes exist in the first active substance layer 400 without resorting to the pore-forming step. According to the pore-forming step, the holes are made larger in size to form the pores.

The pressing step is an essential step in the fabrication of an electrode. Hence, although it is assumed to force the second active substance layer 300 in by the pressing, procedures other than pressing may be actually used without limiting to pressing. Any method may be used if part of the second active substance layer 300 is finally filled in the pores formed in the first active substance layer 400. The pores of the first active substance layer 400 may be passed through the layer. For instance, the second active substance layers 300 facing each other through the first active substance layer 400 may be mutually connected via the through-holes of the pores.

The pore-forming step is one wherein a slurry for forming a first active substance layer 400 is provided, with which a material insoluble in a solvent of the slurry is mixed aside from an active substance, a conductive aid and a binder resin used as solid matters forming the active substance layer, followed by coating to form a first active substance layer 400 on a substrate and removing the insoluble material to form pores at portions where the material has existed. When the first active substance layer 400 is formed via the pore-forming step, the pores are formed in the first active substance layer 400. The pore-forming method is not specifically limited in so far as the constituent materials of the first active substance layer 400 are not eaten away. For example, mention is made of a decomposition method wherein a foaming agent is mixed and heated, a method wherein resin particles are mixed and dissolved with a solvent, a method wherein a liquid having a difference in boiling point from a solvent is mixed and dried in a stepwise manner, and the like. The foaming agent includes an azo compound, a nitroso compound, a hydrazine derivative, a bicarbonate salt and the like. For instance, in the case where the solvent used is water and the binder is styrene-butadiene rubber (SBR), there can be used a method wherein a hydrazine derivative foaming agent is mixed and decomposed by thermal treatment at a temperature lower than the heatproof temperature of the binder, or a method wherein acrylic particles are mixed and dissolved with an alcohol solvent.

### <Effect of the Negative Electrode of the Third Embodiment>

According to the present embodiment, the following effects are shown.

The negative electrode of the present embodiment has such a structure that includes, on a current collector, at least one second active substance layer containing a second active substance capable of reversibly absorbing and releasing lithium, a conductive aid, and a binder resin, and at least one first active substance layer containing a first active substance capable of reversibly alloying with lithium, a conductive aid, and a binder resin, which are alternately stacked one by one in such a way that an outermost active substance layer is the second active substance layer.

In doing so, if the first active substance capable of reversibly alloying with lithium undergoes a great volumetric change ascribed to charge and discharge, the second active substance undergoing a small volumetric change associated with charge and discharge well better acts as a buffer thereto thereby better enabling the respective active substance layers to be broken down. Moreover, since the second active substance layer is formed as an outermost surface, no surface exposure of the first active substance to the outside of the layer is made, so that the fall-off of the first active substance can be prevented. In addition, since the first active substance layer is formed through the pore-forming step, the pores are formed in the first active substance layer and the second active substance layer is forced in the pores of the first active substance layer by pressing to better promote the formation of a mixed layer at the interface between the first and second active substance layers. This enables a better buffer action to be developed thereby better suppressing the breakage of the active substance layers. Thus, there can be try to be provided a negative electrode for nonaqueous-electrolytic-solution secondary cells having a higher capacity and a longer life.

Where the second active substance layer is formed between the current collector and the first active substance layer, the fall-off of the active substance layer from the current collector can be suppressed, making it possible to try to provide a negative electrode for nonaqueous-electrolytic-solution secondary cells having a higher capacity and a longer life.

### <Current Collector>

The current collectors 2, 20, 200 are preferably made of a material of good electric conductivity, respectively. More particularly, they are, respectively, formed of a metal foil itself such as of gold, silver, copper, nickel, a stainless steel, titanium, platinum or the like, or an alloy containing two or more of these metals. Of these, the selection of copper is preferred in view of its relative inexpensiveness in cost and ionization tendency of metal. Moreover, a rolled foil is preferred. The crystals in the rolled foil are arranged in a rolling direction, and such a foil is thus less likely to be cracked when a stress is added thereto, with the advantage of good shapeability during stacking.

### <Active Substance Layers>

The first to third active substance layers are formed, for example, by using a slurry containing an active substance, a conductive aid and a binder resin mixed in a solvent, respectively. In doing so, better flexibility and better stress buffering ability are imparted when compared with the case where an active substance having a great volumetric change is used alone. Accordingly, the respective active substance layers are not broken down, and the fall-off of the first active substance can be better prevented.

For the mixing of the slurry, it is preferred to use a kneading machine capable of applying a high shear force. Specific examples of the kneading machine include a ball mill, a beads mill, a sand mill, a dispersion machine such as an ultrasonic dispersion machine, a planetary mixer, a kneader, a homogenizer, an ultrasonic homogenizer, a blade-type agitator such as a disperger, and the like. Of these, a planetary mixer capable of efficient dispersion by stiff consistency is preferred. As to the solid concentration of the slurry, too high a solid concentration allows the solid matter to coagulate, or too low a concentration causes precipitation during drying, for which the solid concentration has to be appropriately adjusted depending on the type of material used. The method of drying the slurry includes warm air drying, hot air drying, vacuum drying, far-infrared drying, constant temperature/high humidity drying and the like.

The solvent used has to be appropriately selected from those materials, in which solid materials used are readily dispersed. More particularly, mention is made of water, an aqueous solvent obtained by mixing ethanol, N-methylpyrrolidone (NMP) or the like, in water, a cyclic amide solvent such as NMP, a linear amide solvent such as N,N-dimethylformamide, N,N-dimethylacetamide or the like, and an aromatic hydrocarbon such as toluene, xylene or the like.

The first active substance should be a high-capacity material, or a material capable of reversibly alloying with lithium. Although such a material undergoes a great volumetric change ascribed to charge and discharge, it can be used without lowering the charge and discharge cycle characteristics by the effect of the second active substance layer or by the effects of the second and third active substance layers. More particularly, mention is made of a metal element such as Al, Ga, In, Si, Ge, Sn, Pb, As, Sb or Bi, or a compound thereof. Among them, higher-capacity Si is preferred, and the use of its compound leads to a reduced volumetric change although the capacity becomes smaller, thus enabling charge and discharge cycle characteristics to be more improved. The compound of Si includes, for example, LiSiO, SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄ or Si₂N₂O.

The second and third active substances, respectively, have to be a material that reversibly reacts with lithium and is small in volumetric change, or a material capable of reversibly absorbing and releasing lithium without alloying with lithium. Since the volumetric change is small, no fall-off of the active substance ascribed to charge and discharge cycles occurs, so that the first active substance layer can be well retained. Because an actual cell reaction is regulated within a limited voltage range, it is important that the substance be able to well react in the charge and discharge potential range of the material selected as the first active substance. In view of the above, the second and third active substances are preferably a carbon material, respectively. In particular, mention is made of black lead, graphite, carbon black, coke, glassy carbon, carbon fibers, and sintered products thereof. The second and third active substances may not always be made of the same material.

The conductive aid should be appropriately selected from materials that ensure conductivity with the current collector and do not undergo a chemical reaction during the charge and discharge reactions. Although it is preferred to use materials that efficiently allow electron conduction in small amounts, appropriate selection should be made depending on the degree of affinity for an active substance and binder resin. More particularly, mention is made of carbon black, acetylene black, carbon whiskers, carbon fibers, natural graphite, artificial graphite, carbon nanoparticles and nanotubes, titanium oxide, ruthenium oxide, metal powders or fibers such as aluminum, nickel and the like, and mixtures thereof.

The binder resin should be appropriately selected from polymers that are stable in solvents, electrolytic solutions and the reaction potential window of electrodes. More particularly, mention is made of polyethylene (PE), polypropylene (PP), polyethylene terephthalate (PTFE), resin polymers such as aromatic polyamides, rubbery polymers such as styrene/butadiene rubber (SBR), ethylene/propylene rubber and the like, acrylic polymers, polyolefins, polyamides, polyimides, polyamide-imides, epoxy resins, bakelites, fluorine polymers and the like. Examples of the fluorine polymer include polyvinylidene fluoride (PVDF), polytetrafluorethylene, vinylidene fluoride-hexafluoropropylene copolymer, vinylidene fluoride-ethylene chloride trifluoride (CTFE) copolymer, vinylidene fluoride-hexafluoropropylene fluorine rubber, vinylidene fluoride-tetrafluoroethylene-perfluoroalkylvinyl ether fluorine rubber and the like. When used for an active substance whose volumetric change is small, fluorine polymers, such as polyvinylidene fluoride (PVDF), polytetrafluoroethylene and the like, and rubbery polymers, such as styrene-butadiene rubber (SBR), ethylene-propylene rubber and the like, are preferred. In the case where an aqueous solvent, which is able to suppress the amount of heat in processing steps, can be used and an industrial use is intended, the use of low melting SBR is more preferred in view of the point that reduction in environmental load and solvent recovery are not needed and costs can be saved. Especially, where an active substance whose volumetric change is great is used, polyimides showing a great binding force are favorably used.

The solid content ratios in the active substance layer should be appropriately adjusted depending on the types of materials used. If an active substance of poor conductivity is used, it can be necessary to increase the content of a conductive aid so as to make up for load characteristics and reduce the content of a binder resin, but with concern that charge and discharge cycle characteristics may lower. If the formulation ratio or ratios of the materials other than the active substance are too high, a capacity per unit mass or volume lowers, thus needing that appropriate ratios should be selected.

In the case where a plurality of active substance layers are stacked, the compositions of the respective active substance layers may not be the same, and appropriate selection should be made from the standpoint such as of adhesion at the respective interfaces.

For improved characteristics, the usual practice is to adjust the density of the negative electrode by pressing. As a pressing method, mention is made of a metal roll pressing method, a rubber roll pressing method, a flat plate pressing method and the like. The bulk density of an active substance layer after pressing is preferably from 1.0 g/cm² to 3.0 g/cm². If the bulk density exceeds the above range, few voids remain in the active substance layer, so that an electrolytic solution cannot penetrate into the active substance layer thereby lowering a cell performance. On the other hand, if the bulk density is below the above range, an amount of a binder resin contacting a current collector becomes small, thereby causing an adhesion failure between the active substance layer and the current collector.

The negative electrodes 1, 10, 100 are each stacked or wound in face-to-face relation with a positive electrode through a separator for preventing short-circuiting so as to separate the positive electrode and the negative electrode from each other in a cell filled with an electrolytic solution thereby configuring a nonaqueous-electrolytic-solution secondary cell.

The capacities of the positive and negative electrodes should be substantially equal to each other. If the negative electrode capacity is less than the positive electrode capacity, lithium ions, which are released from a positive electrode active substance to an electrolytic solution during charging reaction, cannot fully be absorbed in the negative electrode active substance layer, and excess lithium ions are converted to lithium metal and deposited on the negative electrode in the form of dendrites. This deposit raises some concern that it breaks through the separator between the positive and negative electrodes thereby causing short-circuiting between the positive and negative electrodes, or is fallen in the electrolytic solution to deteriorate the cell performance and also to cause abnormal generation of heat through abrupt reaction with lithium metal. In contrast, if the negative electrode capacity is larger than the positive electrode capacity, most lithium released from the positive electrode active substance during charging reaction is absorbed in the negative electrode active substance in an irreversible state, thereby lowering the charge and discharge cycle capacity. Because no reaction proceeds at a portion where the positive electrode active substance and the negative electrode active substance are not facing each other, both electrodes should be precisely aligned when stacked.

### <Positive Electrode>

Like the negative electrode, the positive electrode is configured of a current collector and an active substance layer formed on the current collector and containing an active substance, a conductive aid and a binder resin. The active substance is not specifically limited so far as it is made of a compound capable of absorbing and releasing lithium ions. As an inorganic compound for the positive electrode active substance, there can be used a composite oxide represented by the compositional formula, LiₓMO₂ or Li_{y}M₂O₄ (wherein M is a transition metal, 0≦x≦1, and 1≦y≦2), oxides having voids on tunnels, layer-structured metal chalcogenides, and lithium ion-containing chalcogen compounds. More particularly, mention is made of the compounds of Group V metals such as LiCoO, NiO₂, Ni₂O₃, Mn₂O₄, LiMn₂O₄, MnO₂, Fe₂O₃, Fe₃O₄, FeO₂, V₂O₅, V₆O₁₃, VOₓ, Nb₂O₅, Bi₂O₃, Sb₂O₃, and the like, the compounds of Group VI metals such as CrO₃, Cr₂O₃, MoO₃, MoS₂, WO₃, SeO₂ and the like, and TiO₂, TiS₂, SiO₂, SnO, CuO, CuO₂, Ag₂O, CuS, CuSO₄ and the like. The transition metals may be in admixture of two or more, or compounds containing two or more of the transition metals, i.e. binary and ternary compounds, may also be used. The organic compounds for the positive electrode active substance include conductive polymer compounds such as polypyrrole, polyaniline, polyparaphenylene, polyacetylene, polyacene and the like. The current collector, conductive aid and binder resin used may be the same materials as with the negative electrode, respectively.

The separator is not specifically limited so far as it is stable against an electrolytic solution, is well impregnated with an electrolytic solution so as to allow development of ion conductivity, and is able to prevent short-circuiting of the positive and negative electrodes. More particularly, mention is made of porous materials including porous polymer films made of polyolefins such as polypropylene and polyethylene, and also of fluorine resins, glass filter, non-woven fabrics.

The electrolytic solution is not specifically limited so far as it shows good ion conductivity and is not decomposed at cell voltage, and includes a solution of a lithium salt serving as a support electrolyte and dissolved in an organic solvent, a polymer electrolyte, an inorganic solid electrolyte and a composite material thereof, and the like. The organic solvents used include linear esters, y-lactones, chain ethers, cyclic ethers and nitriles. Specifically, mention is made of propylene carbonate (PC), ethylene carbonate (EC), butylene carbonate (BC), vinylene carbonate (VC), dimethyl carbonate (DMC), diethyl carbonate (DEC), ethyl methyl carbonate (EMC), dipropyl carbonate (DPC), and the like. As an electrolyte, mention is made of LiBF₄, LiClO₄, LiAlCl₄, LiPF₆, LiAsF₆, LiSbF₆, LiSCN, LiCl, LiBr, LiI, LiCF₃SO₃, LiC₄F₉SO₃, and the like.

### EXAMPLES

Examples of the invention are described, which should not be construed as limiting the invention thereto.

### First Embodiment

Next, a first embodiment is described.

### Example 1

100 parts by mass of Si nanopowder (manufactured by Aldrich Inc.) used as an active substance, 25 parts by mass of vapor phase carbon fibers (VGCF-H, manufactured by Showa Denko K.K.) and 25 parts by mass of acetylene black (Denka Black HS-100, manufactured by Denka Co., Ltd.), both used as a conductive aid, and 25 parts by mass of a polyamide-imide resin (HPC-9000, manufactured by Hitachi Chemical Co., Ltd.) used as a binder resin were provided, to which NMP (manufactured by Mitsubishi Corporation) was appropriately added so as to provide a solid content of 30 mass %, followed by mixing with a planetary mixer for 120 minutes to prepare a slurry for forming a first active substance layer.

The slurry was applied onto a 12 μm thick copper foil (made by Mitsui Mining & Smelting Co., Ltd.), serving as a current collector, by use of a doctor blade applicator and placed in a hot air oven to dry the slurry by treatment at 120° C. for 30 minutes thereby forming a first active substance layer on the current collector.

90 parts by mass of natural graphite (SMG, manufactured by Hitachi Chemical Co., Ltd.) used as an active substance, 10 parts by mass of artificial graphite (SFG-6, manufactured by TIMCAL Inc.) used as a conductive aid, and 25 parts by mass of a polyamide-imide resin (HPC-9000, manufactured by Hitachi Chemical Co., Ltd.) used as a binder resin were provided, to which NMP (manufactured by Mitsubishi Corporation) used as a solvent was added so as to provide a solid content of 40 mass %, followed by mixing with a planetary mixer for 120 minutes to prepare a slurry for forming a second active substance layer.

This slurry was applied onto the first active substance layer by use of a doctor blade applicator and placed in a hot air oven wherein the slurry was dried by treatment at 120° C. for 30 minutes and baked at 200° C. for 3 hours, followed by roll pressing to obtain a negative electrode of Example 1.

### Example 2

In the same manner as in Example 1 except that the first active substance of Example 1 was changed to 100 parts by mass of SiO powder (manufactured by Aldrich Inc.) thereby obtaining a negative electrode of Example 2.

### Example 3

100 parts by mass of Si nanopowder (manufactured by Aldrich Inc.) used as an active substance, 25 parts by mass of vapor phase carbon fibers (VGCF-H, manufactured by Showa Denko K.K.) and 30 parts by mass of acetylene black (Denka Black HS-100, manufactured by Denka Co., Ltd.), both used as a conductive aid, and 1 part by mass of carboxymethyl cellulose ammonium salt (DN-800H, manufactured by Daicel Corporation) and 3 parts by mass of styrene-butadiene rubber (BM-400B, manufactured by Zeon Corporation), both used as a binder resin, were provided, to which water used as a solvent was appropriately added so as to provide a solid content of 45 mass %, followed by mixing with a planetary mixer for 120 minutes to prepare a slurry for forming a first active substance layer.

The slurry was applied onto a 12 μm thick copper foil (made by Mitsui Mining & Smelting Co., Ltd.), serving as a current collector, by use of a doctor blade applicator and placed in a hot air oven to dry the slurry by treatment at 80° C. for 30 minutes thereby forming a first active substance layer on the current collector.

90 parts by mass of natural graphite (SMG, manufactured by Hitachi Chemical Co., Ltd.) used as an active substance, 10 parts by mass of artificial graphite (SFG-6, manufactured by TIMCAL Inc.) used as a conductive aid, and 1 part by mass of carboxymethyl cellulose ammonium salt (DN-800H, manufactured by Daicel Corporation) and 2 parts by mass of styrene-butadiene rubber (BM-400B, manufactured by Zeon Corporation), both used as a binder resin, were provided, to which water used as a solvent was appropriately added so as to provide a solid content of 45 mass %, followed by mixing with a planetary mixer for 120 minutes to prepare a slurry for forming a second active substance layer.

This slurry was applied onto the first active substance layer by use of a doctor blade applicator and placed in a hot air oven wherein the slurry was dried by treatment at 80° C. for 30 minutes, followed by roll pressing to obtain a negative electrode of Example 3.

### Example 4

In the same manner as in Example 3 except that the first active substance of Example 3 was changed to 100 parts by mass of SiO powder (manufactured by Aldrich Inc.) thereby obtaining a negative electrode of Example 4.

### Example 5

100 parts by mass of Si nanopowder (manufactured by Aldrich Inc.) used as an active substance, 10 parts by mass of vapor phase carbon fibers (VGCF-H, manufactured by Showa Denko K.K.) and 10 parts by mass of acetylene black (Denka Black HS-100, manufactured by Denka Co., Ltd.) used as a conductive aid, and 10 part by mass of PVdF (#7200, manufactured by Kureha Battery material Japan Co., Ltd.) used as a binder resin, were provided, to which NMP (Mitsubishi Chemical Corporation) used as a solvent was appropriately added so as to provide a solid content of 55 mass %, followed by mixing with a planetary mixer for 120 minutes to prepare a slurry for forming a first active substance layer.

The slurry was applied onto a 12 μm thick copper foil (made by Mitsui Mining & Smelting Co., Ltd.), serving as a current collector, by use of a doctor blade applicator and placed in a hot air oven to dry the slurry by treatment at 120° C. for 30 minutes thereby forming a first active substance layer on the current collector.

90 parts by mass of natural graphite (SMG, manufactured by Hitachi Chemical Co., Ltd.) used as an active substance, 10 parts by mass of artificial graphite (SFG-6, manufactured by TIMCAL Inc.) used as a conductive aid, and 10 parts by mass of PVdF (#7200, manufactured by Kureha Battery Japan Co., Ltd.) used as a binder resin, were provided, to which NMP (manufactured by Mitsubishi Chemical Corporation) used as a solvent was appropriately added so as to provide a solid content of 55 mass %, followed by mixing with a planetary mixer for 120 minutes to prepare a slurry for forming a second active substance layer.

This slurry was applied onto the first active substance layer by use of a doctor blade applicator and placed in a hot air oven wherein the slurry was dried by treatment at 120° C. for 30 minutes, followed by roll pressing to obtain a negative electrode of Example 5.

### Example 6

In the same manner as in Example 5 except that the first active substance in Example 5 was changed to 100 parts by mass of SiO powder (manufactured by Aldrich Inc.), a negative electrode of Example 6 was obtained.

### Comparative Example 1

In the same manner as in Example 1, the first active substance layer was formed on the current collector, and was subsequently placed in a hot air oven and baked at 200° C. for 3 hours, followed by roll pressing under the same conditions as in Example 1 to provide an electrode of Comparative Example 1.

### Comparative Example 2

In the same manner as in Example 2, the first active substance layer was formed on the current collector, and was subsequently placed in a hot air oven and baked at 200° C. for 3 hours, followed by roll pressing under the same conditions as in Example 2 to provide an electrode of Comparative Example 2.

### Comparative Example 3

In the same manner as in Example 3, the first active substance layer was formed on the current collector, followed by roll pressing under the same conditions as in Example 3 to provide an electrode of Comparative Example 3.

### Comparative Example 4

In the same manner as in Example 4, the first active substance layer was formed on the current collector, followed by roll pressing under the same conditions as in Example 4 to provide an electrode of Comparative Example 4.

### Comparative Example 5

In the same manner as in Example 5, the first active substance layer was formed on the current collector, followed by roll pressing under the same conditions as in Example 5 to provide an electrode of Comparative Example 5.

### Comparative Example 6

In the same manner as in Example 6, the first active substance layer was formed on the current collector, followed by roll pressing under the same conditions as in Example 6 to provide an electrode of Comparative Example 6.

### Evaluation

The negative electrodes of the examples and comparative examples were used to make cells, respectively, and subjected to charge and discharge evaluation.

For making the cells, a positive electrode serving as a counter electrode of the negative electrode was made in the following way. Initially, 90 parts by mass of LiMn₂O₄ (Type-F, manufactured by Mitsui Metal Co., Ltd.), 5 parts by mass of acetylene black used as a conductive agent (Denka Black HS-100, manufactured by Denka Co. Ltd.) and 5 parts by mass of PVDF (#7200, manufactured by Kureha Corporation) used as a binder resin were provided, to which NMP (manufactured by Mitsubishi Chemical Co., Ltd.) used as a solvent was appropriately added so as to provide a solid content of 65 mass %, followed by mixing with a planetary mixer for 120 minutes to prepare a slurry for forming an active substance layer of a positive electrode.

Next, the slurry was coated onto a 15 μm thick aluminum foil (manufactured by Nippon Foil Mfg. Co., Ltd.) serving as a current collector by means of a doctor blade applicator, placed in a hot air oven and treated at 120° C. for 30 minutes to dry the slurry. It will be noted that the coating amount was adjusted in such a way that its capacity was 0.9 times the negative electrode capacity. Thereafter, pressing was performed with a roll press to provide a positive electrode.

The positive electrode and negative electrode were, respectively, punched into 14 mm and 15 mm φ pieces, followed by inserting a 16 mm φ separator therebetween so as not cause short-circuiting between the electrodes and filling an electrolytic solution to provide a coin cell. For the separator, a polyolefin resin fine microporous film (Hipore ND525, manufactured by Asahi Kasei E Materials Corporation) was used. The electrolytic solution used was a solution wherein 1 M of LiPF₆ was dissolved in ethylene carbonate:diethylene carbonate=3:7 to which 2 parts by mass of vinylene carbonate was added.

The coin cell was subjected to charge and discharge evaluation. The charge and discharge were repeated at low rates, and the cycle where no increase in discharge capacity was observed was taken as a first cycle (discharge capacity retention rate of 100%), followed by 100 charge and discharge cycles at rates of 0.2 C and 1 C, respectively. The resulting discharge capacity retention rate is shown in Table 1.

TABLE 1

| | Discharge capacity |
|---|---|
| | retention rate (%) |
| Example 1 | 69.8 |
| Example 2 | 81.5 |
| Example 3 | 62.2 |
| Example 4 | 76.0 |
| Example 5 | 60.1 |
| Example 6 | 72.5 |
| Comparative Example 1 | 63.8 |
| Comparative Example 2 | 76.4 |
| Comparative Example 3 | 51.9 |
| Comparative Example 4 | 72.1 |
| Comparative Example 5 | 55.7 |
| Comparative Example 6 | 70.3 |

As stated above, in Example 1, the first active substance was formed using Si as an active substance and the polyamide-imide resin (which may be hereinafter referred to as PAI) as a binder resin, on which the second active substance layer was formed wherein natural graphite was used as an active substance and PAI used as a binder resin.

In Example 2, SiO was used as an active substance and PAI was used as a binder resin to form the first active substance layer, on which the second active substance layer was formed using natural graphite as an active substance and PAI as a binder resin.

In Example 3, Si was used as an active substance and carboxymethyl cellulose ammonium salt and styrene-butadiene rubber (hereinafter referred to as CMC/SBR) were used as a binder resin to form the first active substance layer, on which the second active substance layer was formed using natural graphite as an active substance and CMC/SBR as a binder resin.

In Example 4, SiO was used as an active substance and CMC/SBR were used as a binder resin to form the first active substance layer, on which the second active substance was formed using natural graphite as an active substance and CMC/SBR as a binder resin.

In Example 5, Si was used as an active substance and PVdF was used as a binder resin to form the first active substance layer, on which the second active substance layer was formed using natural graphite as an active substance and PVdF as a binder resin.

In Example 6, SiO was used as an active substance and PVdF was used as a binder resin to form the first active substance layer, on which the second active substance layer was formed using natural graphite as an active substance and PVdF as a binder resin.

In Comparative Examples 1-6, one layer made of the first active substance layer in the corresponding Examples 1 to 6 was used.

As will be seen from Table 1, the examples making use of different types of active substances and binder resins are improved over the comparative examples with respect to the discharge capacity retention rate. Thus, it was confirmed that when using the electrodes configured as in the examples, there could be made non-aqueous electrolytic secondary cells of a high capacity and a long life.

It will be noted that where Si and SiO are compared with each other for use as an active substance, Si is better in capacity, but SiO is more excellent in cycle characteristics.

Where PAI, PVdF and CMC/SBR are compared with one another, PAI is the best in adhesion but needs a high temperature treatment, for example, of not lower than 200° C. for curing. In addition, NMP used as a solvent causes an environmental load. With PVdf, the thermal treatment is only to dry the slurry, but NMP used as a solvent causes an environmental load. As to CMC/SBR, thermal treatment is only to dry the slurry, and water is used as a solvent and is lowest with respect to process load.

In this way, relative merits are included for every example and thus, appropriate selection should be made depending on the conditions of use.

### Second Embodiment

Next, the second embodiment is described.

### Example 1

90 parts by mass of natural graphite (SMG, manufactured by Hitachi Chemical Co., Ltd.) used as an active substance, 15 parts by mass of artificial graphite (SFG-6, manufactured by TIMCAL Inc.) used as a conductive aid, and 25 parts by mass of a polyamide-imide resin (HPC-9000, manufactured by Hitachi Chemical Co., Ltd.) used as a binder resin were provided, to which NMP (manufactured by Mitsubishi Corporation) was appropriately added so as to provide a solid content of 40 mass %, followed by mixing with a planetary mixer for 120 minutes to prepare a slurry for forming a second active substance layer.

The slurry was applied onto a 12 μm thick copper foil (made by Mitsui Mining & Smelting Co., Ltd.), serving as a current collector, by use of a doctor blade applicator and placed in a hot air oven to dry the slurry by treatment at 120° C. for 30 minutes thereby forming a second active substance on the current collector.

100 parts by mass of Si nanopowder (manufactured by Aldrich Inc.) used as an active substance, 25 parts by mass of vapor phase carbon fibers (VGCF-H, manufactured by Showa Denko K.K.) and 25 parts by mass of acetylene black (Denka Black HS-100, manufactured by Denka Co., Ltd.), both used as a conductive aid, and 25 parts by mass of a polyamide-imide resin (HPC-9000, manufactured by Hitachi Chemical Co., Ltd.) used as a binder resin were provided, to which NMP (manufactured by Mitsubishi Corporation) was appropriately added so as to provide a solid content of 30 mass %, followed by mixing with a planetary mixer for 120 minutes to prepare a slurry for forming a first active substance layer.

The slurry was applied onto the second active substance layer by use of a doctor blade applicator and placed in a hot air oven to dry the slurry by treatment at 120° C. for 30 minutes thereby forming a first active substance on the second active substance layer.

90 parts by mass of natural graphite (SMG, manufactured by Hitachi Chemical Co., Ltd.) used as an active substance, 10 parts by mass of artificial graphite (SFG-6, manufactured by TIMCAL Inc.) used as a conductive aid, and 20 parts by mass of a polyamide-imide resin (HPC-9000, manufactured by Hitachi Chemical Co., Ltd.) used as a binder resin were provided, to which NMP (manufactured by Mitsubishi Corporation) was appropriately added so as to provide a solid content of 40 mass %, followed by mixing with a planetary mixer for 120 minutes to prepare a slurry for forming a third active substance layer.

The slurry was applied onto the first active substance layer by use of a doctor blade applicator and placed in a hot air oven to dry the slurry by treatment at 120° C. for 30 minutes thereby forming a third active substance layer on the first active substance layer, followed by baking at 200° C. for 3 hours and roll pressing to provide a negative electrode of Example 1.

### Example 2

In the same manner as in Example 1 except that the first active substance of Example 1 was changed to 100 parts by mass of SiO powder (manufactured by Aldrich Inc.) thereby obtaining a negative electrode of Example 2.

### Example 3

90 parts by mass of natural graphite (SMG, manufactured by Hitachi Chemical Co., Ltd.) used as an active substance, 10 parts by mass of artificial graphite (SFG-6, manufactured by TIMCAL Inc.) used as a conductive aid, and 1 part by mass of carboxymethyl cellulose ammonium salt (DN-800H, manufactured by Daicel Corporation) and 2 parts by mass of styrene-butadiene rubber (BM-400B, manufactured by Zeon Corporation), both used as a binder resin, were provided, to which water used as a solvent was appropriately added so as to provide a solid content of 45 mass %, followed by mixing with a planetary mixer for 120 minutes to prepare a slurry for forming a second active substance layer.

The slurry was applied onto a 12 μm thick copper foil (made by Mitsui Mining & Smelting Co., Ltd.), serving as a current collector, by use of a doctor blade applicator and placed in a hot air oven to dry the slurry by treatment at 80° C. for 30 minutes thereby forming a second active substance layer on the current collector.

100 parts by mass of Si nanopowder (manufactured by Aldrich Inc.) used as an active substance, 25 parts by mass of vapor phase carbon fibers (VGCF-H, manufactured by Showa Denko K.K.) and 30 parts by mass of acetylene black (Denka Black HS-100, manufactured by Denka Co., Ltd.), both used as a conductive aid, and 1 part by mass of carboxymethyl cellulose ammonium salt (DN-800H, manufactured by Daicel Corporation) and 3 parts by mass of styrene-butadiene rubber (BM-400B, manufactured by Zeon Corporation), both used as a binder resin, were provided, to which water was appropriately added as a solvent so as to provide a solid content of 45 mass %, followed by mixing with a planetary mixer for 120 minutes to prepare a slurry for forming a first active substance layer.

The slurry was applied onto the second active substance layer by use of a doctor blade applicator and placed in a hot air oven to dry the slurry by treatment at 80° C. for 30 minutes thereby forming a first active substance layer on the second active substance layer.

90 parts by mass of natural graphite (SMG, manufactured by Hitachi Chemical Co., Ltd.) used as an active substance, 8 parts by mass of artificial graphite (SFG-6, manufactured by TIMCAL Inc.) used as a conductive aid, and 1 part by mass of carboxymethyl cellulose ammonium salt (DN-800H, manufactured by Daicel Corporation) and 1 part by mass of styrene-butadiene rubber (BM-400B, manufactured by Zeon Corporation), both used as a binder resin, were provided, to which water used as a solvent was appropriately added so as to provide a solid content of 50 mass %, followed by mixing with a planetary mixer for 120 minutes to prepare a slurry for forming a third active substance layer.

The slurry was applied onto the first active substance layer by use of a doctor blade applicator and placed in a hot air oven to dry the slurry by treatment at 80° C. for 30 minutes thereby forming a third active substance layer on the first active substance layer, followed by roll pressing to provide a negative electrode of Example 3.

### Example 4

In the same manner as in Example 3 except that the first active substance was changed to 100 parts by mass of SiO powder (manufactured by Aldrich Inc.), thereby providing a negative electrode of Example 4.

### Example 5

90 parts by mass of natural graphite (SMG, manufactured by Hitachi Chemical Co., Ltd.) used as an active substance, 10 parts by mass of artificial graphite (SFG-6, manufactured by TIMCAL Inc.) used as a conductive aid, and 10 parts by mass of PVdF (#7200, manufactured by Kureha Battery Materials Japan Co., Ltd.) used as a binder resin, were provided, to which NMP used as a solvent was appropriately added so as to provide a solid content of 55 mass %, followed by mixing with a planetary mixer for 120 minutes to prepare a slurry for forming a second active substance layer.

The slurry was applied onto a 12 μm thick copper foil (manufactured by Mitsui Mining and Smelting Co., Ltd.) serving as a current collector by use of a doctor blade applicator and placed in a hot air oven to dry the slurry by treatment at 120° C. for 30 minutes to form a second active substance layer on the current collector.

100 parts by mass of Si nanopowder (manufactured by Aldrich Inc.) used as an active substance, 10 parts by mass of vapor phase carbon fibers (VGCF-H, manufactured by Showa Denko K.K.) and 10 parts by mass of acetylene black (Denka Black HS-100, manufactured by Denka Co., Ltd.), both used as a conductive aid, and 10 parts by mass of PVdF (#7200, manufactured by Kureha Battery Materials Japan Co., Ltd.) used as a binder resin, were provided, to which NMP (manufactured by Mitsubishi Chemical Corporation) used as a solvent was appropriately added so as to provide a solid content of 55 mass %, followed by mixing with a planetary mixer for 120 minutes to prepare a slurry for forming a first active substance layer.

The slurry was applied onto the second active substance layer by use of a doctor blade applicator and placed in a hot air oven to dry the slurry by treatment at 120° C. for 30 minutes thereby forming a first active substance layer on the second active substance layer.

90 parts by mass of natural graphite (SMG, manufactured by Hitachi Chemical Co., Ltd.) used as an active substance, 8 parts by mass of artificial graphite (SFG-6, manufactured by TIMCAL Inc.) used as a conductive aid, and 5 parts by mass of PVdF (#7200, manufactured by Kureha Battery Materials Japan Co., Ltd.) used as a binder resin, were provided, to which NMP (manufactured by Mitsubishi Chemical Corporation) used as a solvent was appropriately added in an amount sufficient to provide a solid content of 50 mass %, followed by mixing with a planetary mixer for 120 minutes to prepare a slurry for forming a third active substance layer.

The slurry was applied onto the first active substance layer by use of a doctor blade applicator and placed in a hot air oven to dry the slurry by treatment at 120° C. for 30 minutes thereby forming a third active substance layer on the first active substance layer, followed by roll pressing to provide a negative electrode of Example 5.

### Example 6

In the same manner as in Example 5 except that the first active substance was changed to 100 parts by mass of SiO powder (manufactured by Aldrich Inc.), thereby providing a negative electrode of Example 6.

### Comparative Example 1

A slurry for forming the same first active substance layer as in Example 1 was applied onto a current collector and treated in a hot air oven at 120° C. for 30 minutes to form a first active substance layer on the current collector. Thereafter, this was placed in a hot air oven and baked at 200° C. for 3 hours and pressed by roll pressing under the same conditions as in Example 1 to provide an electrode of Comparative Example 1.

### Comparative Example 2

A slurry for forming the same first active substance layer as in Example 2 was applied onto a current collector and treated in a hot air oven at 120° C. for 30 minutes to form a first active substance layer on the current collector. Thereafter, this was placed in a hot air oven and baked at 200° C. for 3 hours and pressed by roll pressing under the same conditions as in Example 2 to provide an electrode of Comparative Example 2.

### Comparative Example 3

A slurry for forming the same first active substance layer as in Example 3 was applied onto a current collector and treated in a hot air oven at 80° C. for 30 minutes to form a first active substance layer on the current collector. Thereafter, this was pressed by roll pressing under the same conditions as in Example 3 to provide an electrode of Comparative Example 3.

### Comparative Example 4

A slurry for forming the same first active substance layer as in Example 4 was applied onto a current collector and treated in a hot air oven at 80° C. for 30 minutes to form a first active substance layer on the current collector. Thereafter, this was pressed by roll pressing under the same conditions as in Example 4 to provide an electrode of Comparative Example 4.

### Comparative Example 5

A slurry for forming the same first active substance layer as in Example 5 was applied onto a current collector and treated in a hot air oven at 120° C. for 30 minutes to form a first active substance layer on the current collector. Thereafter, this was pressed by roll pressing under the same conditions as in Example 5 to provide an electrode of Comparative Example 5.

### Comparative Example 6

A slurry for forming the same first active substance layer as in Example 6 was applied onto a current collector and treated in a hot air oven at 120° C. for 30 minutes to form a first active substance layer on the current collector. Thereafter, this was pressed by roll pressing under the same conditions as in Example 6 to provide an electrode of Comparative Example 6.

### Evaluation

Cells were made using the respective negative electrodes of the examples and comparative examples and subjected to charge and discharge evaluation.

In a cell configuration, a positive electrode serving as a counter electrode of the negative electrode was made in the following way. Initially, 90 parts by mass of LiMn₂O₄ (Type-F, manufactured by Mitsui Metal Co., Ltd.), 5 parts by mass of acetylene black (Denka Black HS-100, manufactured by Denka Co. Ltd.) used as a conductive agent, and 5 parts by mass of PVdF (#7200, manufactured by Kureha Corporation) used as a binder resin were provided, to which NMP (manufactured by Mitsubishi Chemical Co., Ltd.) used as a solvent was appropriately added so that the solid content was 65 mass %, followed by mixing with a planetary mixer for 120 minutes to prepare a slurry for forming an active substance layer of a positive electrode.

Next, the slurry was coated onto a 15 μm thick aluminum foil (manufactured by Nippon Foil Mfg. Co., Ltd.) serving as a current collector by means of a doctor blade applicator, placed in a hot air oven and treated at 120° C. for 30 minutes to dry the slurry. It will be noted that the coating amount was adjusted in such a way that its capacity was 0.9 times the negative electrode capacity. Thereafter, pressing was performed with a roll press to provide a positive electrode.

The positive electrode and negative electrode were, respectively, punched into 14 mm φ and 15 mm φ pieces, followed by inserting a 16 mm φ separator therebetween so as not to cause short-circuiting between the electrodes and filling an electrolytic solution to provide a coin cell. For the separator, a polyolefin resin fine microporous film (Hipore ND525, manufactured by Asahi Kasei E Materials Corporation) was used. The electrolytic solution used was a solution wherein 1 M of LiPF₆ was dissolved in ethylene carbonate:diethylene carbonate=3:7, to which 2 parts by mass of vinylene carbonate was added.

The coin cell was subjected to charge and discharge evaluation. More particularly, the charge and discharge were repeated at low rates, and the cycle where no increase in discharge capacity was observed was taken as a first cycle (discharge capacity retention rate of 100%), followed by 100 charge and discharge cycles at rates of 0.2 C and 1 C, respectively. The resulting discharge capacity retention rate is shown in Table 2.

TABLE 2

| | Discharge capacity |
|---|---|
| | retention rate (%) |
| Example 1 | 71.2 |
| Example 2 | 82.8 |
| Example 3 | 65.9 |
| Example 4 | 79.8 |
| Example 5 | 63.7 |
| Example 6 | 76.5 |
| Comparative Example 1 | 63.8 |
| Comparative Example 2 | 76.4 |
| Comparative Example 3 | 51.9 |
| Comparative Example 4 | 72.1 |
| Comparative Example 5 | 55.7 |
| Comparative Example 6 | 70.3 |

As stated above, in Example 1, the first active substance layer was formed using Si as an active substance and PAI as a binder resin, on and below which the second active substance layer was formed wherein natural graphite was used as an active substance and PAI used as a binder resin, thereby providing the three layers.

In Example 2, SiO was used as an active substance and PAI was used as a binder resin to form the first active substance layer, on and below which the second active substance layer was formed using natural graphite as an active substance and PAI as a binder resin, thereby providing the three layers.

In Example 3, Si was used as an active substance and CMC/SBR were used as a binder resin to form the first active substance layer, on and below which the second active substance layer was formed using natural graphite as an active substance and CMC/SBR as a binder resin, thereby providing the three layers.

In Example 4, SiO was used as an active substance and CMC/SBR were used as a binder resin to form the first active substance layer, on and below which the second active substance was formed using natural graphite as an active substance and PVdF as a binder resin, thereby providing the three layers.

In Example 5, Si was used as an active substance and PVdF was used as a binder resin to form the first active substance layer, on and below which the second active substance layer was formed using natural graphite as an active substance and PVdF as a binder resin, thereby providing the three layers.

In Example 6, SiO was used as an active substance and PVdF was used as a binder resin to form the first active substance layer, on and below which the second active substance layer was formed using natural graphite as an active substance and PVdF as a binder resin, thereby providing the three layers.

In Comparative Examples 1-6, one layer made of the first active substance layer in the corresponding Examples 1 to 6 was used.

As will be seen from Table 2, where the examples making use of different types of active substances and binder resins were adopted, the discharge capacity retention rate was improved over the comparative examples. From the above, it was confirmed that when using the electrodes configured as in the examples, there could be made non-aqueous-electrolytic-solution secondary cells of a high capacity and a long life.

It will be noted that where Si and SiO are compared with each other for use as an active substance, Si is better in capacity, but SiO is more excellent in cycle characteristics.

Where PAI, PVdF and CMC/SBR are compared with one another, PAI is the best in adhesion but needs a high temperature treatment, for example, of not lower than 200° C. for curing. In addition, NMP used as a solvent causes an environmental load. With PVdf, the thermal treatment is only to dry the slurry, but NMP used as a solvent causes an environmental load. As to CMC/SBR, thermal treatment is only to dry the slurry, and water is used as a solvent and is thus the lowest with respect to process load.

In this way, relative merits are included for every example and thus, appropriate selection should be made depending on the conditions of use.

### Third Embodiment

Next, a third embodiment is described.

### Example 1

100 parts by mass of Si nanopowder (manufactured by Aldrich Inc.) used as an active substance, 25 parts by mass of vapor phase carbon fibers (“VGCF-H”, manufactured by Showa Denko K.K.) and 25 parts by mass of acetylene black (“Denka Black HS-100”, manufactured by Denka Co., Ltd.), both used as a conductive aid, 1 part by mass of carboxymethyl cellulose ammonium salt (“DN-800H”, manufactured by Daicel Corporation) and 3 parts by mass of styrene-butadiene rubber (“BM-400B”, manufactured by Zeon Corporation), both used as a binder resin, and 5 parts by mass of hydrazine derivative foaming agent A (4,4′-oxbows(benzenesulfonylhydrazide) with a foaming temperature of 155° C.) and 5 parts by mass of a urea foaming aid (acting to lower a foaming initiation temperature to 127° C.), both used as a pore-forming material, were provided, to which water serving as a solvent was appropriately added so as to provide a solid content of 45 mass %, followed by mixing with a planetary mixer for 120 minutes to prepare a slurry for forming a first active substance layer.

The slurry was applied onto a 12 μm thick copper foil (made by Mitsui Mining & Smelting Co., Ltd.), serving as a current collector, by use of a doctor blade applicator and placed in a hot air oven, followed by drying at 80° C. and removing the foaming agent at 130° C. to form a first active substance layer on the current collector.

Next, 90 parts by mass of natural graphite (“SMG”, manufactured by Hitachi Chemical Co., Ltd.) used as an active substance, 10 parts by mass of artificial graphite (“SFG-6”, manufactured by TIMCAL Inc.) used as a conductive aid, and 1 part by mass of carboxymethyl cellulose ammonium salt and 2 parts by mass of styrene-butadiene rubber, both used as a binder resin were provided, to which water used as a solvent was appropriately added in a manner as to provide a solid content of 50 mass %, followed by mixing with a planetary mixer for 120 minutes to prepare a slurry for forming a second active substance layer.

The slurry was applied onto the first active substance layer by use of a doctor blade applicator and placed in a hot air oven and dried at 80° C., followed by roll pressing to obtain a negative electrode of Example 1.

### Example 2

In the same manner as in Example 1 except that the second active substance was formed beforehand on the current collector prior to the formation of the first active substance layer, a negative electrode of Example 2 was obtained.

### Example 3

In the same manner as in Example 1 except that 7 parts by mass of an azo compound foaming agent A (azodicarbonamide with a foaming temperature of 140° C.) was used as a pore-forming material and the removing temperature of the foaming agent was set at 145° C., a negative electrode of Example 3 was obtained.

### Example 4

In the same manner as in Example 3 except that the second active substance layer was formed beforehand on the current collector prior to the formation of the first active substance layer, a negative electrode of Example 4 was obtained.

Next, comparative examples for comparison with the examples of the invention are described.

### Comparative Example 1

In the same manner as in Example 1 without use of a pore-forming material in the slurry for forming the first active substance layer, a first active conductive substance layer was formed on the current collector, followed by roll pressing to provide a negative electrode of Comparative Example 1.

### Comparative Example 2

After forming the first active substance layer in the same manner as in Comparative Example 1, a second active substance layer was formed in the same manner as in Example 1, followed by roll pressing to obtain a negative electrode of Comparative Example 2.

### Comparative Example 3

In the same manner as in Comparative Example 2 except that the second active substance was formed beforehand on the current collector prior to the formation of the first active substance layer, a negative electrode of Comparative Example 3 was obtained.

### Evaluation

The negative electrodes of the examples and comparative examples were used to make cells, respectively, and subjected to charge and discharge evaluation.

For making the cells, a positive electrode serving as a counter electrode of the negative electrode was made in the following way. Initially, 90 parts by mass of LiMn₂O₄ (“Type-F”, manufactured by Mitsui Metal Co., Ltd.), 5 parts by mass of acetylene black (Denka Black HS-100, manufactured by Denka Co. Ltd.) used as a conductive agent, and 5 parts by mass of PVdF (“#7200”, manufactured by Kureha Battery Materials Japan Co. Ltd.) used as a binder resin were provided, to which NMP (manufactured by Mitsubishi Chemical Co., Ltd.) used as a solvent was appropriately added so that the solid content was mass %, followed by mixing with a planetary mixer for 120 minutes to prepare a slurry for forming an active substance layer of a positive electrode.

Next, the slurry was coated onto a 15 μm thick aluminum foil (manufactured by Nippon Foil Mfg. Co., Ltd.) serving as a current collector by means of a doctor blade applicator, placed in a hot air oven and treated at 120° C. for 30 minutes to dry the slurry. It will be noted that the coating amount was adjusted in such a way that its capacity was 0.9 times the negative electrode capacity. Thereafter, pressing was performed with a roll press to provide a positive electrode. The positive electrode and negative electrode were, respectively, punched into 14 mm and 15 mm φ pieces, followed by inserting a 16 mm φ separator therebetween so as not cause short-circuiting between the electrodes and filling an electrolytic solution to provide a coin cell. For the separator, a polyolefin resin fine microporous film (“Hipore ND525”, manufactured by Asahi Kasei E Materials Corporation) was used. The electrolytic solution used was a solution wherein 1 M of LiPF₆ was dissolved in ethylene carbonate:diethylene carbonate=3:7, to which 2 parts by mass of vinylene carbonate was added.

The coin cell was subjected to charge and discharge evaluation. The low-rate charge and discharge were repeated, and the cycle where no increase in discharge capacity was observed was taken as a first cycle (discharge capacity retention rate of 100%), followed by 100 charge and discharge cycles at rates of 0.2 C and 1 C, respectively. The resulting discharge capacity retention rate of the respective cells is shown in Table 3.

TABLE 3

| | Discharge capacity |
|---|---|
| | retention rate (%) |
| Example 1 | 64.7 |
| Example 2 | 69.0 |
| Example 3 | 63.8 |
| Example 4 | 67.5 |
| Comparative Example 1 | 51.9 |
| Comparative Example 2 | 62.2 |
| Comparative Example 3 | 65.9 |

As stated above, in Example 1, the first active substance layer was formed using Si as an active substance, CMC/SBR as a binder resin, and a hydrazine derivative foaming agent as a pore-forming material, on which the second active substance layer was formed wherein natural graphite was used as an active substance and PAI used as a binder resin, thereby providing the two layers.

In Example 2, SiO was used as an active substance, CMC/SBR was used as a binder resin and a hydrazine derivative foaming agent was used as a pore-forming material to form the first active substance layer, on and below which the second active substance layer was formed using natural graphite as an active substance and CMC/SBR as a binder resin, thereby providing the three layers,

In Example 3, Si was used as an active substance, CMC/SBR was used as a binder resin, and an azo compound foaming agent was used as a pore-forming material to form the first active substance layer, on which the second active substance layer was formed using natural graphite as an active substance and CMC/SBR as a binder resin, thereby providing the two layers.

In Example 4, Si was used as an active substance, CMC/SBR was used as a binder resin, and an azo compound foaming agent was used as a pore forming material to form the first active substance layer, on and below which the second active substance layer was formed using natural graphite as an active substance and CMC/SBR as a binder resin, thereby providing the three layers.

In Comparative Example 1, only one layer made of the first active substance layer of Example 1 except that no pre-forming material was used was provided.

In Comparative Example 2, a two-layer structure similar to Example 1 except that no pore-forming material was used was provided.

In Comparative Example 3, a three-layer structure similar to Example 2 except that no pore-forming material was used was provided.

As shown in Table 3, where the examples of the invention were adopted, the discharge capacity retention rate was improved over the case of the comparative examples dealing with the single-layer and the same layer structures. In view of the above, it was confirmed that when using the electrodes configured in the examples, nonaqueous-electrolytic-solution secondary cells of a high capacity and a long life could be fabricated.

As to the pores formed in the first active substance layer, although better results are obtained in the above examples when using a hydrazine derivative foaming agent as a foaming agent for pore formation, it is assumed that because an electrode structure differs depending on the pore shape and an optimum pore structure differs depending on the type of negative electrode material, the optimum type of foaming agent should be chosen depending on the electrode structure.

Although the cycle characteristics are improved by increasing the number of the laminated first active substance layers, fabrication costs are increased by an increasing number of steps.

Hence, the respective examples have relative merits and should be appropriately selected depending on the conditions of use.

Although the present invention has been illustrated by way of a limited number of embodiments, the scope of the invention should not be construed as limited thereto and modifications of the embodiments based on the disclosure of the invention will become apparent to those skilled in the art.

### INDUSTRIAL APPLICABILITY

The negative electrode for nonaqueous-electrolytic-solution secondary cells of the invention includes, on a current collector, a first active substance layer containing a first active substance capable of reversibly alloying with lithium, a conductive aid, and a binder resin, the first active substance layer being covered with a second active substance layer containing a second active substance layer capable of reversibly absorbing and releasing lithium, a conductive aid and a binder resin. Therefore, the active substance can be prevented from falling off during charge and discharge cycles, and there can be provide a negative electrode for nonaqueous-electrolytic-solution secondary cells of a high capacity and a long life.

### REFERENCE SIGNS LIST

1, 10, 100 negative electrode
2, 20, 200 current collector
3, 30, 400 first active substance layer
4, 40, 300 second active substance layer
5 mixed layer of first and second active substance layers
50 third active substance layer
60 mixed layer of first and second active substance layers
70 mixed layer of first and third active substance layers
500 mixed layer of first and second active substance layers

What is claimed is:

1. A negative electrode for nonaqueous-electrolytic-solution secondary cells, comprising:
a first active substance layer that contains a first active substance capable of reversibly alloying with lithium, a conductive aid, and a resin binder;
a second active substance layer covering at least a portion of the first active substance layer, and containing a second active substance capable of reversibly absorbing and releasing lithium without alloying with lithium, a conductive aid, and a binder resin.

2. The negative electrode of claim 1, further comprising that the second active substance layer sandwiches the first active substance layer on opposite sides of the first active substance layer to cover the first active substance layer.

3. The negative electrode of claim 1, further comprising that at least one first active substance layer and at least one second active substance layer are alternately formed in a one-by-one layered arrangement in such a way that an outermost active substance layer is the second active substance layer.

4. The negative electrode of claim 1, further comprising a mixed interlayer that is formed between the first active substance layer and the second active substance layer by mixing together at least a part of the constituent substances of each of the two layers to form the mixed interlayer.

5. The negative electrode of claim 4, wherein the mixed interlayer is formed in such a way that a part of the components of the first active substance layer is incorporated in the second active substance layer.

6. The negative electrode of claim 4, wherein the mixed interlayer is formed at the interface between the second active substance layer and the first active substance layer in such a way that a part of the second active substance layer is filled in pore portions formed in the first active substance layer.

7. The negative electrode of claim 1, further comprising a current collector that is a metal foil made of a metal selected from the group consisting of gold, silver, copper, nickel, a stainless steel, titanium, platinum, or an alloy of two or more metals thereof.

8. The negative electrode of claim 1, wherein the first active substance is selected from the group consisting of metal elements of Al, Ga, In, Si, Ge, Sn, Pb, As, Sb, and Bi, and compounds thereof.

9. The negative electrode of claim 1, wherein the second active substance is selected from the group consisting of black lead, graphite, coke, glassy carbon, carbon fibers, compounds thereof, and sintered products thereof.

10. A nonaqueous-electrolytic-solution secondary cell, comprising:
the negative electrode for nonaqueous-electrolytic-solution secondary cells of claim 1, and,
an active substance layer of a positive electrode and either the first active substance layer or the second active substance layer being stacked to be facing each other.

11. A method for making a negative electrode for nonaqueous-electrolytic-solution secondary cells comprising:
forming a first active substance layer containing a first active substance capable of reversibly alloying with lithium, a conductive aid and a binder resin;
forming a second active substance layer containing a second active substance layer capable of reversibly absorbing and releasing lithium without alloying with lithium;
forming at least one mixed interlayer between the first active substance layer and the second active substance layer adjacent to each other by mixing at least a part of the constituent substances of the first active substance layer and at least a part of the constituent substances of the second active substance layer,
successively coating and drying slurries for forming the first active substance layer and the second active layer wherein the binder resin of one of the adjacent first or second active substance layers is dissolved in a solvent of the slurry for forming the other adjacent first or second active substance layer, to form the mixed interlayer.

12. The method for making a negative electrode of claim 11, wherein the binder resin of the first active substance layer is dissolved in the solvent of the slurry for forming the second active substance layer to form the mixed interlayer layer.

13. A method for making a negative electrode for nonaqueous-electrolytic-solution secondary cells comprising:
forming a first active substance layer containing a first active substance capable of reversibly alloying with lithium, a conductive aid and a binder resin;
forming a second active substance layer containing a second active substance layer capable of reversibly absorbing and releasing lithium without alloying with lithium;
forming at least one mixed interlayer between the first active substance layer and the second active substance layer adjacent to each other by mixing at least a part of the constituent substances of the first active substance layer and at least a part of the constituent substances of the second active substance; and,
successively coating and drying slurries for forming the respective first and second active substance layers onto a current collector, and subsequently pressing the stacked first and second active substance layers simultaneously, whereby a mixed interlayer is formed between the adjacent first and second active substance layers by the pressing.

14. The method for making a negative electrode of claim 13, wherein the mixed interlayer is formed by pressing at least a portion of the components of the first active substance layer into the second active substance layer.

15. A method for making a negative electrode for nonaqueous-electrolytic-solution secondary cells by forming a plurality of active substance layers on a current collector, the method comprising:
alternately stacking, one by one, at least one first active substance layer containing a first active substance capable of reversibly alloying with lithium, a conductive aid and a binder resin and at least one second active substance layer containing a second active substance capable of reversibly absorbing and releasing lithium, a conductive aid and a binder resin in such a way that the second active substance layer is an outermost active substance layer of the negative electrode for nonaqueous-electrolytic-solution secondary cells;
forming pores in the first active substance layer; and
filling the second active substance layer in the pores of the first active substance layer to form a mixed interlayer at the interface between the first active substance layer and the second active substance layer.
